(19) United States
(12) Patent Application Publication
(10) Pub. No.: US 2014/0140000 A1
(43) Pub. Date: May 22, 2014

(54) INFORMATION APPARATUS

(71) Applicant: KABUSHIKI KAISHA TOSHIBA, Tokyo (JP)

(72) Inventors: Toshio Ooe, Akishima-shi (JP); Keiichi Mitsui, Kokubunji-shi (JP)

(21) Appl. No.: 13/922,474

(22) Filed: Jun. 20, 2013

(30) Foreign Application Priority Data
Nov. 16, 2012 (JP) 2012-252112

(51) Int. Cl. G06F 1/16

(52) U.S. Cl. CPC G06F 1/1675; G06F 1/1677
USPC 361/679.56

(57) ABSTRACT

According to one embodiment, an information apparatus includes a stand received in the receiving portion of a housing. The receiving portion has an attachment recess for receiving a chip card. A card slot for inserting the chip card therein is formed in a wall of the attachment recess.

### CROSS-REFERENCE TO RELATED APPLICATIONS

This application is based upon and claims the benefit of priority from Japanese Patent Application No. 2012-252112, filed Nov. 16, 2012, the entire contents of which are incorporated herein by reference.

### FIELD

Embodiments described herein relate generally to an information apparatus having an attachment structure for attaching a chip card such as SIM (Subscriber Identification Module) card.

### BACKGROUND

PC cards provided with chip cards, such as SIM cards, are known.

PC cards of this type are utilized as, for example, transceiver terminals for wireless communication, which identify a user by emitting identification information of the chip cards to information apparatuses.

The SIM cards are known as devices having low resistance against impact and being easily broken due to impact.

Therefore, it is desirable that the attachment structure for the SIM cards should prevent external forces from exerting on the SIM cards as far as possible.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view illustrating the appearance of an information apparatus according to an embodiment;

FIG. 2 is a perspective view illustrating the information apparatus of FIG. 1 set in a portrait attitude;

FIG. 3 is a perspective view illustrating a stand located at the backside of the information apparatus of FIG. 1;

FIG. 4 is a perspective view illustrating an attachment recess formed in the stand receiving portion shown in FIG. 3;

FIG. 5 is a cross sectional view taken along line F5-F5 of FIG. 1;

FIG. 6 is a partially enlarged view illustrating a state in which the lid of the attachment recess shown in FIG. 4 is opened;

FIG. 7 is a partially enlarged view illustrating a state in which the lid shown in FIG. 6 is removed;

FIG. 8 is a partially enlarged view illustrating a state in which the receiving portion and the attachment recess are cut along line F8-F8 of FIG. 6; and

FIG. 9 is a perspective view illustrating the lid of FIG. 6 viewed from the attachment recess side.

### DETAILED DESCRIPTION

Various embodiments will be described hereinafter with reference to the accompanying drawings. In general, according to one embodiment, an information apparatus has a stand received in a receiving portion provided in a housing. The receiving portion includes an attachment recess for attaching a chip card. A card slot is provided in a wall of the attachment recess to receive the chip card.

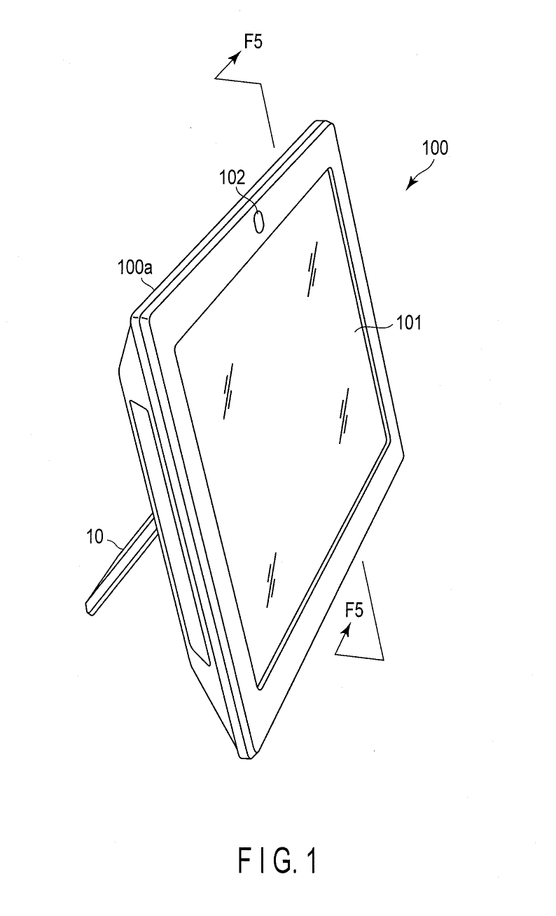

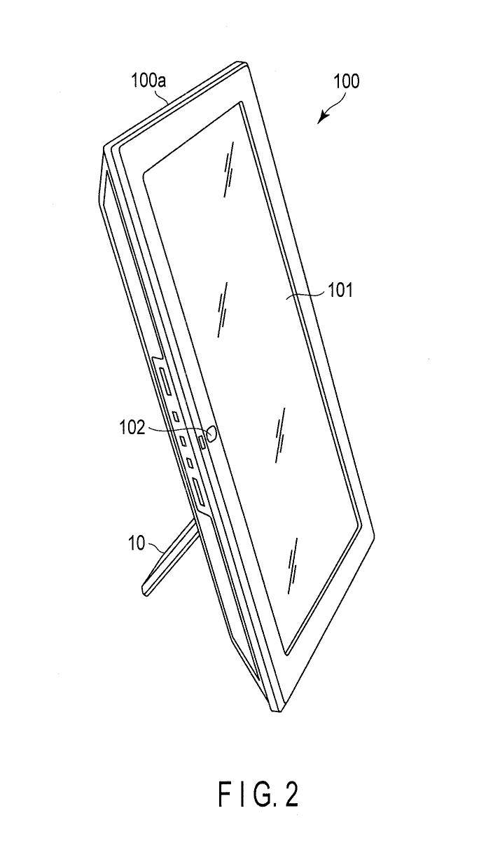

FIGS. 1 and 2 are perspective views illustrating the appearance of a digital photo-frame (hereinafter, a photo-frame) 100 as an example of the information apparatus. FIG. 1 shows the photo-frame 100 set in a landscape attitude (i.e., the longitudinal axis of the frame is positioned horizontally). FIG. 2 shows the photo-frame 100 set in a portrait attitude (i.e., the lateral axis of the photo-frame is positioned horizontally). In the description below, assuming that the photo-frame 100 is set in the landscape attitude, the upper, lower, right and left directions are defined.

The photo-frame 100 comprises a liquid crystal display 101 at its front side. A camera 102 is provided above the liquid crystal display 101. To the photo-frame 100, a memory card (not shown) can be detachably attached as a storage unit for storing images photographed by an external device. A stand 10 that enables the photo-frame 100 to be set in the landscape or portrait attitude is provided at the backside of the photo-frame 100.

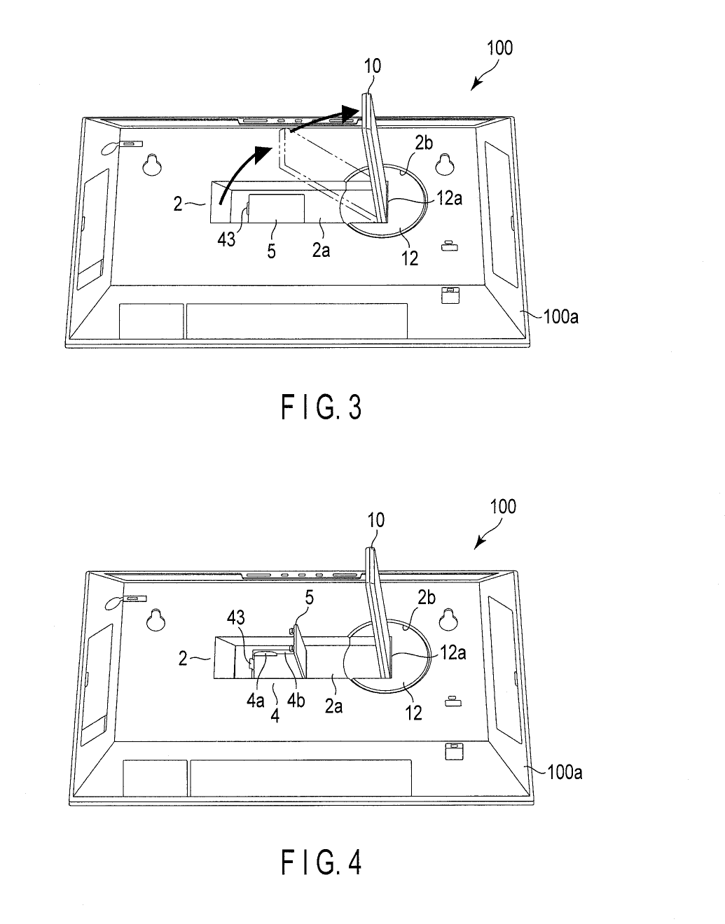

FIGS. 3 and 4 are perspective views illustrating the photo-frame 100 viewed from behind. FIG. 3 shows a state in which the stand 10 is raised from a receiving portion 2, and FIG. 4 shows a state in which a lid 5 (lid member) for an attachment recess 4 formed in the bottom 2a of the receiving portion 2 is open. As shown in FIG. 4, a card slot 4a is provided in the attachment recess 4 for fitting therein an SIM card 20 (chip card) (the card 20 is not shown in FIG. 4).

The SIM card 20 is an IC card for storing identification information used to identify the user of the photo-frame 100. Namely, if the SIM card 20 is mounted in another photo-frame, said another photo-frame can recognize the identification information stored in the SIM card. In general, however, when the SIM card 20 is once mounted in a particular information apparatus, it is not re-mounted into another information apparatus.

The stand 10 is provided such that it can be received in and raised from the receiving portion 2 that is a recess formed in the backside of the housing 100a of the photo-frame 100. The receiving portion 2 is a substantially rectangular recess formed in the housing 100a along the length thereof. The one-dot chain line in FIG. 3 shows the stand 10 that is being raised from the receiving portion 2.

A rotary member 12 is provided at the right end of the receiving portion 2 for rotating the stand 10 through a desired angle. The rotary member 12 has a hinge portion 12a to which the proximal end of the stand 10 is rotatably attached. The rotary member 2 is fitted in a substantially circular recess 2b formed continuous with the right end (in FIGS. 3 and 4) of the receiving portion 2, so that it is rotatable and will not drop out of the recess 2b.

When the rotary member 12 is rotated to the position shown in FIG. 3 and the stand 10 is pulled out of (i.e., raised from) the receiving portion 2, the photo-frame 100 can be set in the portrait attitude. In contrast, to set the photo-frame 100 in the landscape attitude, the stand 10 is raised from the receiving portion 2, and then the rotary member 12 is clockwise rotated through 90 degrees from the state shown in FIG. 3.

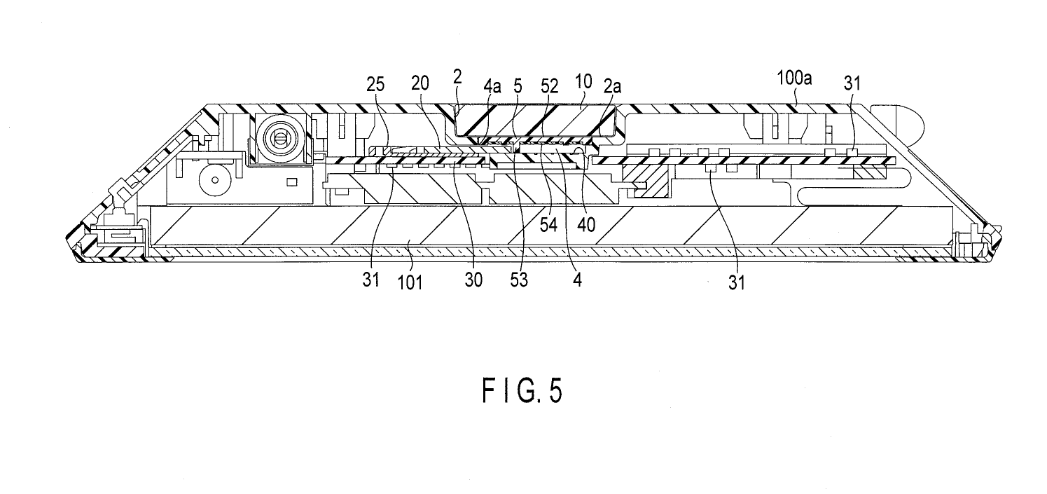

FIG. 5 is a cross sectional view of the photo-frame 100 taken along line F5-F5 of FIG. 1. FIG. 1 shows a state in which the stand 10 is pulled out for use, while FIG. 5 is a cross sectional view illustrating a state in which the stand 10 is received in the receiving portion 2.

In the housing 100a, a circuit board 30 with a plurality of electronic components 31 mounted thereon is provided at the backside of the aforementioned liquid crystal display 101. A socket 25 for mounting the SIM card 20 is provided at the backside of the circuit board 30.

The opening of the socket 25 for inserting the SIM card 20, i.e., a card slot 4a (see FIGS. 4 and 5), is formed in a side wall 4b of the attachment recess 4 deeper than the bottom 2a of the receiving portion 2 for the stand 10. When the photo-frame 100 is set in the landscape attitude, the card slot 4a is positioned at the upper portion of the side wall 4b (see FIG. 4) of the attachment recess 4. Namely, the socket 25 is positioned by the circuit board 30 so that the opening for inserting the SIM card 20 opposes the card slot 4a. Since the attachment recess 4 is deeper than the bottom 2a of the receiving portion 2, the socket 25 can be directly attached to the circuit board 30 without using, for example, a small circuit board.

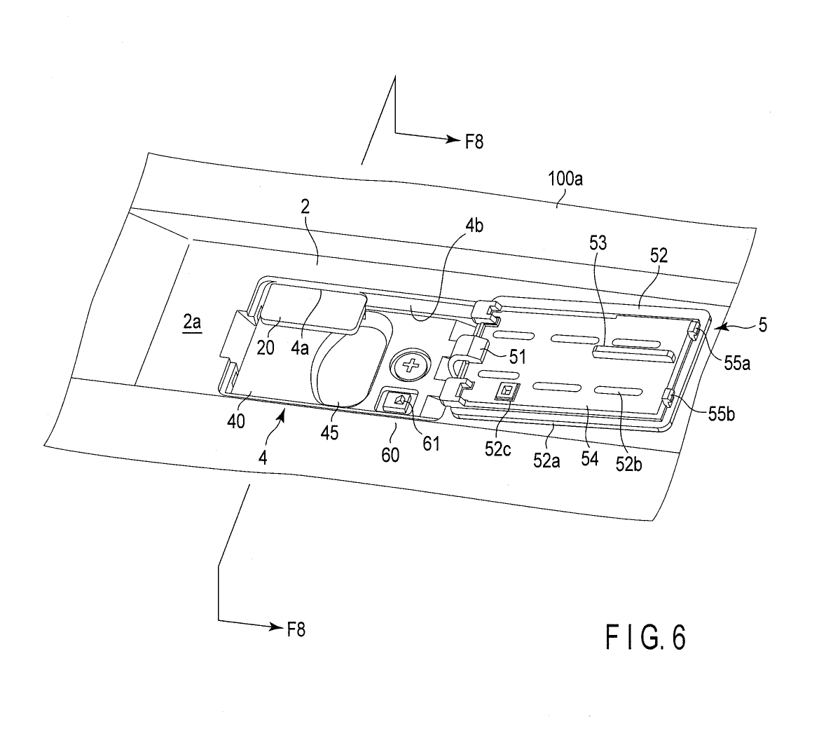

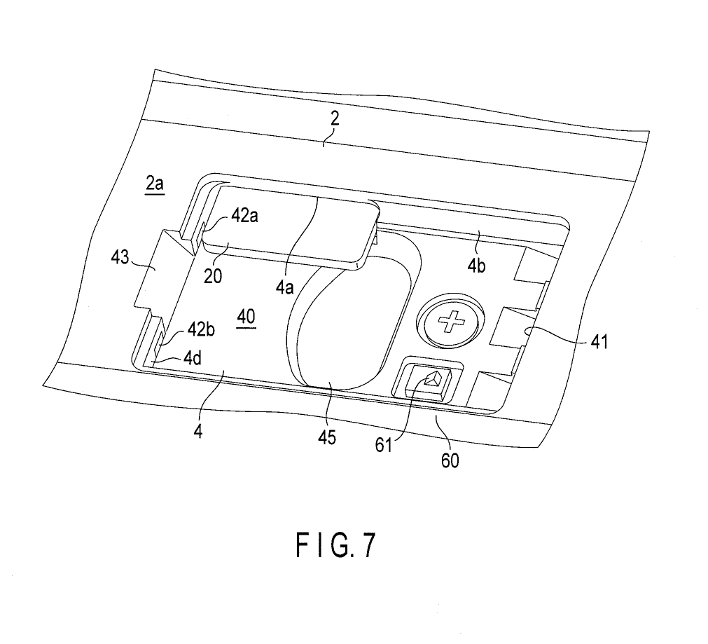

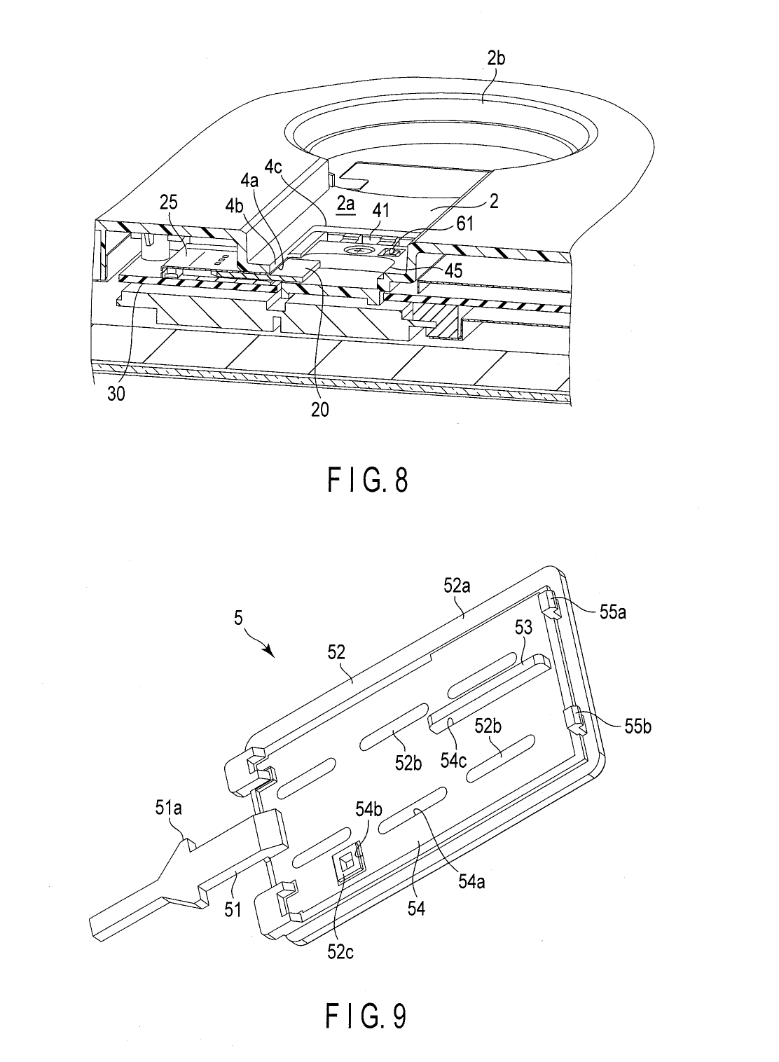

Referring now to FIGS. 6 to 9, a detailed description will be given of an attachment structure for attaching the SIM card 20. FIG. 6 is a partially enlarged view illustrating a state in which the lid 5 of the above-described attachment recess 4 is wide open. FIG. 7 is a further enlarged view illustrating the attachment recess 4 viewed when the lid 5 is removed. FIG. 8 is a cross sectional view of the receiving portion 2 for the stand 10 and the attachment recess 4 for the SIM card 20, taken along the center line (i.e., along line F8-F8 of FIG. 6) of the SIM card 20 extending in the insertion direction of the SIM card 20. FIG. 9 is a perspective view of the lid 5 viewed from the attachment recess 4 side, i.e., from within.

As shown in FIGS. 6 and 8, the receiving portion 2 for receiving the stand 10 is a recess formed in the housing 100a of the photo-frame 100 from the backside thereof. Accordingly, when the stand 10 is received in the receiving portion 2, the surface of the stand 10 is substantially level with the backside of the housing 100a.

Further, the attachment recess 4 is positioned deeper in the housing 100a than the bottom 2a of the receiving portion 2. When the attachment recess 4 is closed with the lid 5, the surface of the lid 5 is substantially level with the bottom 2a of the receiving portion 2 as shown in FIGS. 3 and 5.

Namely, when the stand 10 is received in the receiving portion 2, the lid 5 is covered with the stand 10. In other words, when the SIM card 20 is inserted in the card slot 4a of the attachment recess 4, it is covered with two lids, i.e., the stand 10 and the lid 5, which substantially eliminates exertion of an undesired external force on the SIM card 20. Thus, the SIM card 20 can be sufficiently protected.

Further, as shown in, for example, FIG. 6, the width of the attachment recess 4 (parallel with the line F8-F8) is set narrower than the width (parallel with the line F8-F8) of the bottom 2a of the receiving portion 2. Accordingly, when the lid 5 of the attachment recess 4 is opened and closed, the opposite sides of the lid 5 extending along the length of the receiving portion 2 are prevented from interfering with the longitudinal inner walls of the receiving portion 2, and the lid 5 can move widthwise.

The lid 5 is connected to an edge of the attachment recess 4 by a flexibly deformable connecting chip 51 as shown in FIG. 9. When the lid 5 is attached to the attachment recess 4, the tip of the connecting chip 51 is inserted into a hole 41 formed in another side wall 4c of the attachment recess 4 different from the side wall 4b with the card slot 4a formed therein. At this time, a V-shaped enlarged portion 51a included in the connecting chip 51 is deformed and passed through the hole 41. After passing through the hole 41, the V-shaped enlarged portion prevents the lid 5 from being detached from the receiving portion 2.

As shown in FIG. 9, the lid 5 is formed by coinjection molding of a relatively hard resin and a relatively soft resin. More specifically, the lid 5 comprises a first portion 52 formed of the relatively hard resin and a second portion 54 formed of the relatively soft resin. At the inner surface side at which the first and second portions 52 and 54 overlap, the first portion 52 has a frame-shaped projecting portion 52a extending along the periphery of the second portion, and a plurality of linear ribs 52b extending along the length of the second portion. Further, on the inner surface of the first portion 52, a relatively small frame-shaped projection 52c for receiving a projection 61 incorporated in a switch 60, described later, is provided. Yet further, on the inner surface of the first portion 52, a card stopper 53 (see FIG. 5) is provided for preventing detachment of the SIM card 20 from the card slot 4a of the attachment recess 4.

The relatively soft second portion 54 overlaps inside the frame-shaped projection 52a as the peripheral portion of the first portion 52. The second portion 54 comprises a plurality of slits 54a for passing therethrough the ribs 52b of the first portion 52, and a rectangular hole 54b for passing therethrough the frame-shaped projection 52c of the first portion 52. The second portion 54 also has a long slit 54c for passing therethrough the card stopper 53 integrally projecting from the inner surface of the first portion 52. The second portion 54 further includes, at one longitudinal end thereof, the aforementioned connecting chip 51 functioning as a hinge. Since the second portion 54 is formed of a flexible bendable material, the lid 5 can be set openable and closable using the connecting chip 51 as a hinge.

Further, the lid 5 has two claws 55a and 55b at an end opposite to the end with the connecting chip 51. The two claws 55a and 55b are separate from each other and integrally project from the relatively hard first portion 52. When the lid 5 is closed, the two claws are latched in two holes 42a and 42b formed in the corresponding side wall 4d of the attachment recess 4. A depression 43 for permitting escape of a claw to be engaged with the lid 5 is formed in the side wall 4b between the two holes 42a and 42b.

As shown in the enlarged view of FIG. 7, the SIM card 20 has a size that enables the rear portion of the card to partially project in the attachment recess 4 when it is inserted in the card slot 4a. When the SIM card 20 is inserted into and pulled out of the card slot 4a, the rear portion of the card is picked by fingers. In this case, since little space exists between the SIM card 20 and the bottom 40 of the attachment recess 4 as shown in FIG. 5, a recess 45 for permitting a finger to escape is formed in the bottom 40 of the attachment recess 4.

For instance, when the SIM card 20 is pulled out of the card slot 4a by picking the rear portion of the card in the state shown in FIG. 6, it may be picked and held by the thumb and index finger of the right hand. In this case, the tip of the index finger is inserted into the recess 45. At this time, it is necessary to open the lid 5 of the attachment recess 4 as shown in FIG. 6. However, a restoration force is exerted on the lid 5 because the connecting chip 51 of the lid 5 is deformable as described above. In view of this, in the embodiment, the recess 45 is arranged between the position at which the SIM card 20 is picked, and the hinge portion of the lid 5, so that the SIM card 20 can be picked with the lid 5 held by the second joint of the index finger of the right hand as shown.

Further, a switch 60 is provided on the bottom 40 of the attachment recess 4 at the position opposing the frame-shaped projection 52c of the lid 52. The switch 60 is used to supply power to the SIM card 20 or interrupt the supply of power thereto.

A projection 61 on the switch 60 is arranged so that it can be protruded against and retracted from the bottom 40. In accordance with the closing operation of the lid 5, the projection 61 is pressed into the frame-shaped projection 52c. Since the frame-shaped projection 52c is formed integral with the relatively hard first portion 52, the projection 61 of the switch 60 is pressed by the hard portion of the lid 5 to thereby realize reliable switching.

When the lid 5 is closed to block the attachment recess 4, the top of the projection 61 of the switch 60 is brought into contact with the bottom of the frame-shaped projection 52c, whereby the projection 61 is pressed down by the bottom of the frame-shaped projection 52c to turn on the switch 60. In contrast, when the lid is open, the bottom of the frame-shaped projection 52c is detached from the top of the projection 61, whereby the projection 61 is returned to the initial position (shown in FIGS. 6 and 7) by a spring (not shown) to thereby turn off the switch 60. When the switch 60 is in the ON state, power is supplied to the SIM card 20, while when it is in the OFF state, the supply of power to the SIM card 20 is interrupted.

The projection 61 of the switch 60 has a pointed tip, which facilitates insertion of the projection tip to be easily inserted into the central hole of the frame-shaped projection 52c. Namely, since the lid 5 is attached via the connecting chip 51 so that it can move relatively freely, the tip of the projection 61 can be easily guided into the central hole of the frame-shaped projection 52c when the lid 5 is attempted to cover the opening of the attachment recess 4, with the center of the lid deviated from the center of the opening. Further, since the tip of the projection 61 is pointed, the area of the projection 61 pressed by the bottom of the frame-shaped projection 52c is reduced, which enable more reliable switching.

As shown in FIG. 6, the switch 60 is provided close to the hinge portion of the lid 5, more particularly, provided at the portion of the bottom 40 closer to the hinge portion than to the recess 45 for permitting a finger to escape. Accordingly, compared to the case where the switch 60 is provided closer to the position which the distal end of the lid 5 reaches when the lid is rotated, for example, to the left side of the recess 45, the torque for pressing down the projection 61 of the switch 60 can be increased, thereby enabling more reliable switching.

The lid 5 is constructed to be closed in synchronism with the stand receiving operation. Namely, since there is little clearance between the surface of the lid 5 and the surface of the stand 10 when the lid 5 is closed and the stand 10 is received as shown in FIG. 5, if the stand 10 is received in the receiving portion 2 with the lid kept open, the lid 5 is pressed by the stand 10 to close the attachment recess 4.

In this case, it is necessary to make the direction of rotation of the stand 10 during receiving the stand 10 be the same as that of rotation of the lid 5 during closure of the lid 5. Namely, in the embodiment, the opening/closing directions of the lid 5 are made to be the same as those of the stand 10 by positioning the hinge portion (second hinge) as the center of rotation of the lid 5 at the side wall 4c of the attachment recess 4 close to the hinge portion 12a (first hinge) of the stand 10. As a result, the lid 5 can be closed in synchronism with the stand receiving operation.

In contrast, if the hinge portion of the lid 5 is provided on the side wall 4d of the attachment recess 4 opposite to the side wall 4c, the distal end of the lid 5 may be brought, during rotation of the lid, into contact with the stand 10 that is being received in the receiving portion 2. Namely, the lid 5 may interrupt receiving of the stand 10 into the receiving portion 2.

As described above, in the embodiment, since the attachment recess 4 is formed in the bottom 2a of the stand receiving portion 2, and the card slot 4a for inserting the SIM card 20 is formed in the side wall 4b of the attachment recess 4, the SIM card 20 can be inserted at the position at which no external force is exerted. In particular, in the embodiment, the lid 5 is provided in the attachment recess 4, the SIM card 20 can be doubly covered with two lids, thereby reinforcing the security. This means that the SIM card 20 can be protected from being damaged by an undesirable external force, and therefore from failure or data loss.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

Although in the embodiment, the invention is applied to the digital photo-frame 100 as an example of an information apparatus, it is not limited to it, but is also applicable to other types of information apparatuses, such as a note PC, a tablet PC and a small size TV set.

Further, although in the embodiment, the case where the SIM card 20 as an example of a chip card is inserted in the photo-frame 100 has been described, the invention is not limited to this, but may be applied to an attachment structure for another chip card.

What is claimed is:

1. An information apparatus comprising:
a housing;
a stand;
a receiving portion in the housing configured to receive the stand;
an attachment recess in the receiving portion; and
a card slot in a wall of the attachment recess configured to receive a chip card.

2. The information apparatus of claim 1, further comprising a lid configured to close the attachment recess.

3. The information apparatus of claim 2, further comprising a switch configured to permit supply of power to the chip card when the attachment recess is closed, and to interrupt the supply of power to the chip card when the attachment recess is open.

4. The information apparatus of claim 2, wherein the lid comprises a card stopper configured to prevent the chip card detached from the card slot when the attachment recess is closed.

5. The information apparatus of claim 2, wherein
the stand is rotatable about a first hinge on an edge of the receiving portion, between a received position at which the stand is received in the receiving portion, and a use position at which the stand projects for use; and
the lid is configured to rotate about a second hinge on an edge of the attachment recess close to the first hinge, between a closed position at which the lid closes the attachment recess, and an open position at which the lid opens the attachment recess.

6. The information apparatus of claim 5, wherein the lid is rotated to close the attachment recess when the receiving portion receives the stand.

7. The information apparatus of claim 2, wherein a peripheral edge of the receiving portion comprises a peripheral edge of the attachment recess, and the lid is configured not to interfere with side walls of the receiving portion when the lid is closed or opened.

8. The information apparatus of claim 1, wherein
a surface of the housing comprises the receiving portion; and
a bottom of the receiving portion comprises the attachment recess.

9. The information apparatus of claim 1, wherein
a side wall of the attachment recess comprises the card slot; and
a bottom of the attachment recess comprises a depression configured to permit escape of an object which picks a portion of the chip card projecting from the card slot when the chip card is inserted in the card slot.

10. The information apparatus of claim 9, wherein
the lid is rotatable about a second hinge on an edge of the attachment recess, between a closed position at which the lid closes the attachment recess, and an open position at which the lid opens the attachment recess; and
the depression is between a position at which the chip card is picked, and the second hinge.
